(19) United States
(12) Patent Application Publication
(10) Pub. No.: US 2017/0299946 A1
(43) Pub. Date: Oct. 19, 2017

(54) LENS MODULE AND ASSEMBLING METHOD THEREOF

(71) Applicant: BISON ELECTRONICS INC., Taipei City (TW)

(72) Inventors: Mung-Shiue Lai, Taoyuan County (TW); Chun-Hung Wu, Taipei City (TW); Chi-Feng Yu, Taipei City (TW)

(21) Appl. No.: 15/203,980

(22) Filed: Jul. 7, 2016

(30) Foreign Application Priority Data
Apr. 13, 2016 (TW) 105111497

(51) Int. Cl. G03B 17/12; G02B 7/02

(52) U.S. Cl. CPC G03B 17/12; G02B 7/021

(57) ABSTRACT

A lens module and an assembling method therefor are provided. The lens module includes a holder and lens barrel. The holder is formed with an annular inner-wall therein. The annular inner-wall is formed with a receiving space. The lens barrel has a main housing which is assembled in the receiving space. The main housing of the lens barrel and the receiving space of the holder are closely fit. The holder and the lens barrel are adjusted for focusing, and the holder and the lens barrel are joined fixedly by one or more glue-parts. This invention does not need a screw thread and has no gap, so that the overall dimension of the lens module can be reduced effectively. Thus, this invention can provide a lens module with a width narrower than the conventional art.

### BACKGROUND OF THE INVENTION

### 1. Field of the Invention

The present invention is related to a lens module and assembling method thereof. In particular, the present invention relates to a lens module including a holder and a lens barrel, and a method for assembling the lens module.

### 2. Description of Related Art

With the development and progress of science and technology, portable devices, such as mobile phone, tablet computer, netbook or notebook, have become an indispensable tool in daily life. The portable device is usually equipped with a camera module, so as to conveniently fulfill the user requirement of capturing images.

Currently, the trend in development of the camera module is slim height and narrow width, and the camera module is mainly composed of a circuit board, image sensor, lens module and other electronic elements. The focusing height of the lens element and the size of the lens have the most influence on the height and width of the camera module. However, the lens barrel and the holder of the lens module are assembled using a type of screw-thread. Further, it is limited by plastic injection, so that the diameter and the width of the lens barrel and the holder are hard to reduce. Thus, the overall dimension of the lens module is hard to reduce, and it is difficult to produce a camera module narrower than the conventional camera module.

Therefore, a lens module and assembling method thereof to overcome the above-mentioned problems is proposed.

### SUMMARY OF THE INVENTION

It is one objective of this invention to provide a lens module and assembling method thereof, having a structure without a screw thread and gaps, to reduce a thickness of screw thread type and effectively minimize an overall dimension of lens module, and the lens module has a narrower width than a conventional lens module.

In order to achieve the above objectives, one embodiment according to the present invention provides a lens module, which includes a holder and a lens barrel. The holder has an annular internal wall-surface formed therein, and a receiving space formed in the annular internal wall-surface. The lens barrel has a main housing, and an annular external wall-surface formed on an external periphery of the main housing. The main housing of the lens barrel is installed in the receiving space of the holder, and the main housing of the lens barrel is tightly fitted in the receiving space of the holder. A glue-part is fixedly applied between the holder and the lens barrel after a focal length between the holder and the lens barrel is adjusted.

In order to achieve the above objectives, one embodiment according to the present invention further provides a method for assembling a lens module, which includes the steps: providing a holder and a lens barrel; wherein the holder has an annular internal wall-surface formed therein, and a receiving space formed in the annular internal wall-surface; wherein the lens barrel has a main housing, and an annular external wall-surface formed on a periphery of the main housing; assembling the main housing of the lens barrel in the receiving space of the holder, and tightly fitting the main housing of the lens barrel in the receiving space of the holder, and adjusting a focal distance between the holder and the lens barrel; and dispensing a glue-part between the holder and the lens barrel for fixedly adhering, after adjusting a focal distance between the holder and the lens barrel.

According to one embodiment of the present invention, the annular internal wall-surface and the annular external wall-surface are conical-shaped. An internal diameter of the annular internal wall-surface is gradually tapered off from one end thereof to the other end thereof. An external diameter of the annular external wall-surface is gradually tapered off from one end thereof to the other end thereof.

Thus, the present invention has advantages as follows. The lens module is designed in a sleeve type so as to fulfill the requirement of reducing width. The precision of the sleeve type is better than that of a screw-thread type, so that the present invention can greatly enhance the precision of the focusing process, and focusing can be easier and clearer. In addition, the sleeve-type lens module of the present invention can be focused by fixture on machine equipment, so the manufacturing technology is much more advanced and stable related to the conventional art.

In addition, the annular internal wall-surface and the annular external wall-surface are conical-shaped, so that an effective well orientation is provided, where the main housing of the lens barrel is assembled in the receiving space of the holder.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is a perspective assembled view of lens module of the present invention.

FIG. 2 is a perspective exploded view of lens module of the present invention.

FIG. 3 is a cross-sectional view of lens module of the present invention.

FIG. 4 is a flow chat of a method for assembling a lens module of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

### First Embodiment

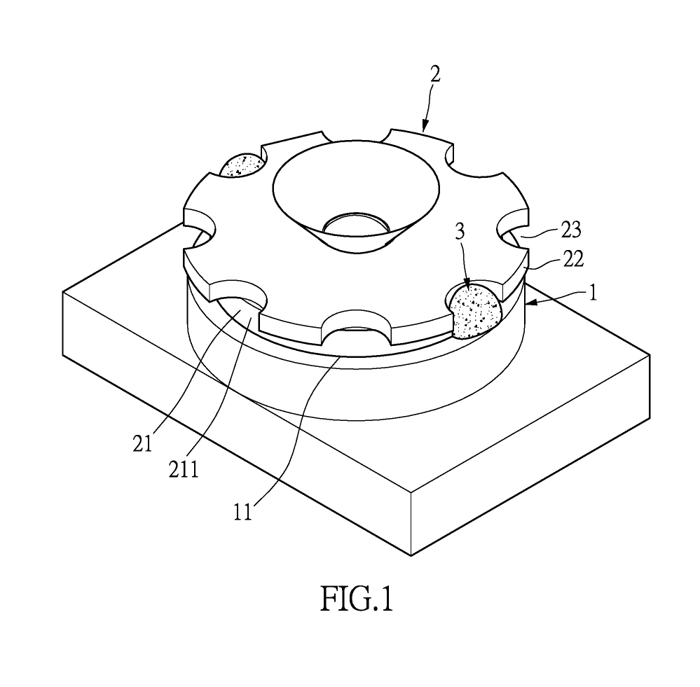

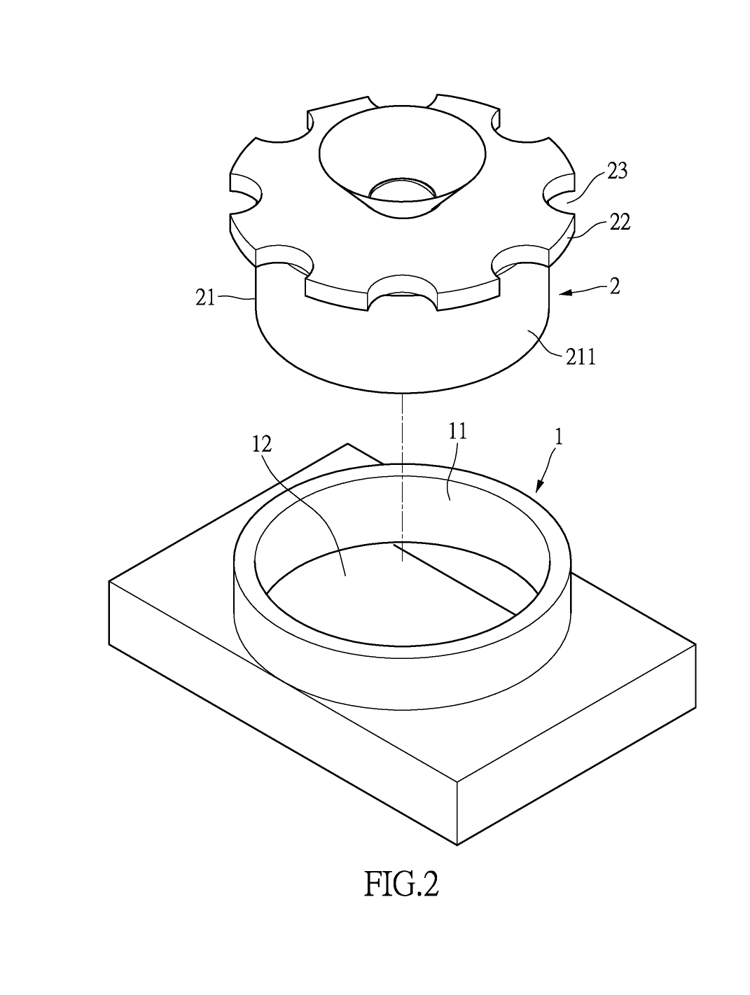

Please refer to FIG. 1 to FIG. 3. The present invention provides a lens module. The lens module includes a holder 1 and a lens barrel 2. The holder 1 is hollow-shaped. An inner side of the holder 1 is formed with an annular internal wall-surface 11. The annular internal wall-surface 11 is formed without threads, and could be a smooth surface. The annular internal wall-surface 11 is formed with a receiving space 12 therein for receiving the lens barrel 2. In particular, the holder 1 could be a circular cylindrical shell. The receiving space 12 is a cylindrical space, and two ends of the receiving space 12 are opened. The receiving space 12 passes through two ends of the annular internal wall-surface 11. The lens barrel 2 can be inserted into one end of the receiving space 12, such as the upper end shown in FIG. 2.

The annular internal wall-surface 11 can be straight cylindrical-shaped. Namely, an internal diameter of the annular internal wall-surface 11 can be equidimensional. The annular internal wall-surface 11 can also be conical-shaped. Namely, the inner diameter of the annular internal wall-surface 11 can have a conical degree. The internal diameter of the annular internal wall-surface 11 is gradually tapered off from one end thereof (upper end as shown in FIG. 2) to the other end thereof (lower end as shown in FIG. 2).

The lens barrel 2 has a main housing 21, and at least one lens (not shown) is disposed in the main housing 21. Since the main housing 21 having a lens disposed therein is conventional technology and is not an emphasized point of the present invention, it is not described more. The main housing 21 has a shape which is matched with a shape of the receiving space 12, so that the main housing 21 can be conveniently assembled in the receiving space 12 of the holder 1. In particular, the main housing 21 could be a cylinder enclosure corresponding to the receiving space 12. The main housing 21 has an annular external wall-surface 211 formed on an external periphery thereof. In this embodiment, the annular external wall-surface 211 is designed without a screw thread. The annular external wall-surface 211 could be straight cylindrical-shaped, in other words, an external diameter of the annular external wall-surface 211 can have a constant diameter. Otherwise, the annular external wall-surface 211 also can be tapered and cone-shaped. An external diameter of the annular external wall-surface 211 could be formed with a conical degree. The external diameter of the annular external wall-surface 211 is gradually tapered off from one end of the annular external wall-surface 211 (the upper end as shown in FIG. 2) to the other end of the annular external wall-surface 211 (the lower end as shown in FIG. 2), so as to match with the annular internal wall-surface 11.

The conical degree of the annular internal wall-surface 11 and the annular external wall-surface 211 are not limited, but for example, can be between 1 to 5 degrees. Forming a slight conical degree on the annular internal wall-surface 11 and the annular external wall-surface 211 can provide orientation effectiveness when the main housing 21 of the lens barrel 2 is assembled in the receiving space 12 of the holder 1.

The main housing 21 of the lens barrel 2 is assembled in the receiving space 12 of the holder 1. Between the main housing 21 of the lens barrel 2 and the receiving space 12 of the holder 1, there is no screw thread. Thus, the main housing 21 of the lens barrel 2 and the receiving space 12 of the holder 1 can be tightly fixed. Namely, when the main housing 21 of the lens barrel 2 is assembled in the receiving space 12 of the holder 1, there is no gap between the holder 1 and the main housing 21 of the lens barrel 2. The annular internal wall-surface 11 of the holder 1 can tightly contact the annular external wall-surface 211 of the lens barrel 2.

After the holder 1 and the lens barrel 2 are adjusted for focusing, the holder 1 and the lens barrel the 2 can be adhesively fixed by a glue-part 3. For example, glue can be dispensed between one end of the holder 1 and one end of the main housing 21 of the lens barrel 2, so that the holder 1 and the lens barrel 2 can be adhesively fixed to each other by the glue-part 3.

In this embodiment, the main housing 21 of the lens barrel 2 further has a protruded flange 22 formed on one end thereof. The protruded flange 22 is annually formed around one end of the main housing 21. The protruded flange 22 is extended along a radial direction of the main housing 21 and protruded from the annular external wall-surface 211. There are at least two cutout portions 23 formed on the protruded flange 22 at intervals. In this embodiment, the protruded flange 22 has a plurality of cutout portions 23 formed thereon at intervals, so as to conveniently dispense glue through some proper chosen cutout portion 23.

After the main housing 21 of the lens barrel 2 is assembled in the receiving space 12 of the holder 1, the protruded flange 22 is arranged outside the receiving space 12 of the holder 1. The protruded flange 22 is disposed above the holder 1. In this embodiment, the protruded flange 22 is closer to one end of the holder 1, so that glue can be dispensed between the holder 1 and the lens barrel 2 through the cutout portion 23 after the holder 1 and the lens barrel 2 are adjusted to a focus. Glue-parts 3 are adhered between the holder 1 and the lens barrel 2. It is preferably has two glue-parts 3, as an example, which are disposed at two opposite sides of the holder and the lens barrel respectively. Thus, the holder 1 and the lens barrel 2 can be adhered firmly and fixedly.

Further, an image sensor (not shown) can be disposed under the holder 1. The image sensor can be used to transfer an image to an electrical signal, and the types of the image sensor are not limited, but are for example, CCD (Charge Coupled Device) or CMOS (Complementary Metal-Oxide-Semiconductor Transistor) . . . etc.

### Second Embodiment

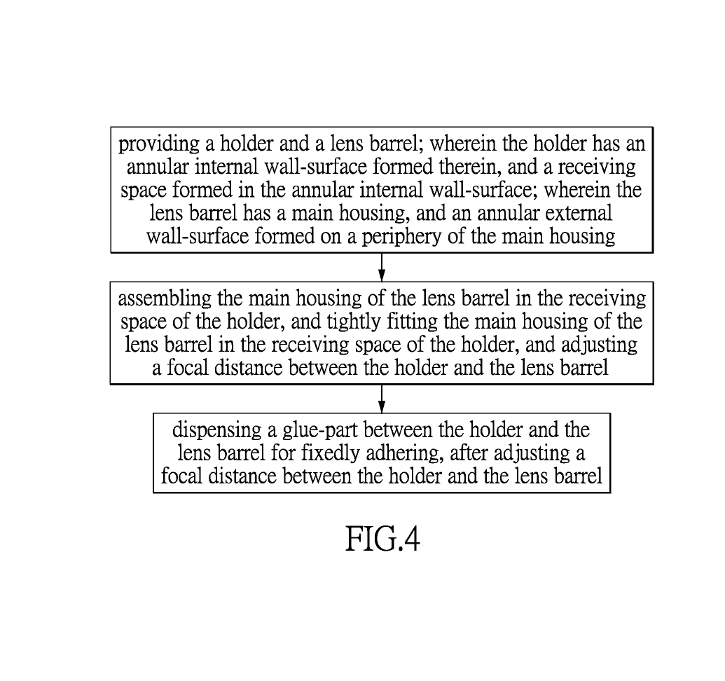

Please refer to FIG. 4, the present invention further provides a method for assembling a lens module, which includes the steps as follows.

First, a holder 1 and a lens barrel 2 (as shown in FIG. 2) are provided. The holder 1 has an annular internal wall-surface 11 formed therein, and a receiving space 12 is formed in the annular internal wall-surface 11. The lens barrel 2 has a main housing 21, and an annular external wall-surface 211 formed on an external periphery of the main housing 21. Since the structure of the holder 1 and the lens barrel 2 are the same as the above embodiment, it is not described again.

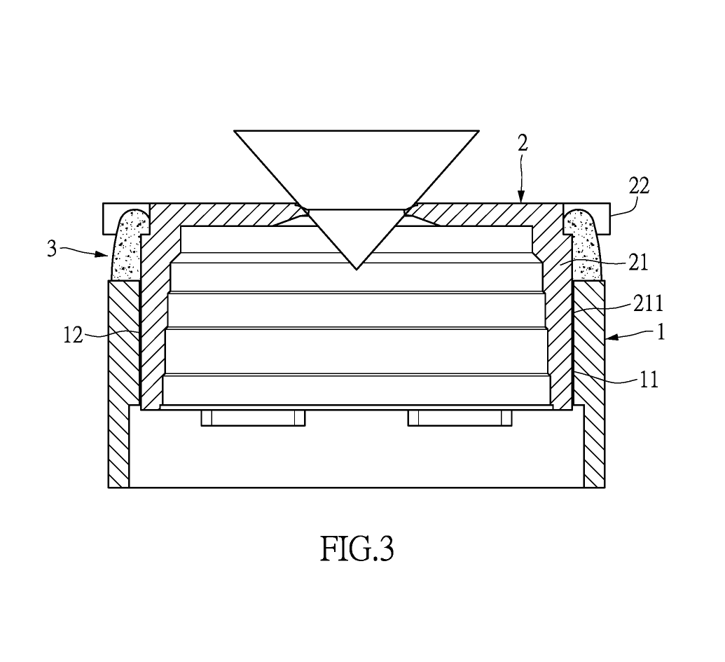

Then, the main housing 21 of the lens barrel 2 is assembled in the receiving space 12 of the holder 1, as shown in FIG. 1 and FIG. 3. The main housing 21 of the lens barrel 2 and the receiving space 12 of the holder 1 are tightly fixed. Focus adjustment can be processed between the holder 1 and the lens barrel 2. Namely, the lens barrel 2 can be adjusted related to the holder 1 along an axial direction.

After the holder 1 and the lens barrel 2 are adjusted for focusing, a glue dispensing step is processed and the holder and the lens barrel are joined fixedly by glue. In this embodiment, the main housing 21 has a protruded flange 22 formed on one end thereof, and a plurality of cutout portions 23 formed on the protruded flange 22 at intervals. Thus, glue can be dispensed through the cutout portions 23 between the holder 1 and the lens barrel 2, after a focal distance between the holder 1 and the lens barrel 2 has been adjusted. The glue-parts 3 are applied between the holder 1 and the lens barrel 2. After the glue-parts 3 are cured, the holder 1 and the lens barrel 2 is fixedly adhered by the glue-parts 3. This embodiment can conveniently perform a glue dispensing process by the cutout portion 23 from a position above the lens module. If there were no cutout portion 23, the glue dispensing process would need to be proceeded from one side of the lens module.

In addition, the annular internal wall-surface 11 and the annular external wall-surface 211 of the present invention can be conical-shaped, so that it can provide an effective well orientation when the main housing 21 of the lens barrel 2 is assembled in the receiving space 12 of the holder 1. An effective orientation in an axial direction is provided for the holder 1 and the lens barrel 2.

Compared with the conventional technology, the lens module of the present invention has no thread in structure and is without a gap, so that it can reduces a thickness of the screw thread of a thread structure. Thus, the overall dimension of the lens module can be effectively downsized, and it can make a camera module slimmer than the conventional art due to the reduction in size of the lens module of the present invention.

The lens module of the present invention is designed in a sleeve type so as to fulfill the requirement of reducing width. The precision of the sleeve type is better than that of screw-thread type, so that the present invention can greatly enhance the precision of the focusing process, and focusing can be easier and clearer. In addition, the sleeve-type lens module of the present invention can be focused by fixture on machine equipment, the manufacturing technology is much more advanced and stable related to the conventional art.

The descriptions illustrated supra set forth simply the preferred embodiments of the present invention; however, the characteristics of the present invention are by no means restricted thereto. All changes, alterations, or modifications conveniently considered by those skilled in the art are deemed to be encompassed within the scope of the present invention delineated by the following claims.

What is claimed is:

1. A lens module, comprising:
a holder, having an annular internal wall-surface formed therein, and a receiving space formed in the annular internal wall-surface; and
a lens barrel, having a main housing, and an annular external wall-surface formed on an external periphery of the main housing, wherein the main housing of the lens barrel is installed in the receiving space of the holder, and the main housing of the lens barrel is tightly fitted in the receiving space of the holder, wherein a glue-part is fixedly applied between the holder and the lens barrel after a focal length between the holder and the lens barrel is adjusted.

2. The lens module as claimed in claim 1, wherein the annular internal wall-surface and the annular external wall-surface are conical-shaped, wherein an internal diameter of the annular internal wall-surface is gradually tapered off from one end thereof to the other end thereof, wherein an external diameter of the annular external wall-surface is gradually tapered off from one end thereof to the other end thereof.

3. The lens module as claimed in claim 1, wherein the annular internal wall-surface and the annular external wall-surface are straight cylindrical-shaped.

4. The lens module as claimed in claim 1, wherein a quantity of the glue-part is two, the two glue-parts are disposed at two opposite sides of the holder and the lens barrel respectively.

5. The lens module as claimed in claim 4, wherein the main housing has a protruded flange formed annularly on one end thereof, and at least two cutout portions formed on the protruded flange at intervals, wherein the protruded flange is extended along a radial direction of the main housing and protruded from the annular external wall-surface, and the protruded flange is arranged outside of the receiving space of the holder, the protruded flange is adjacent to one end of the holder, wherein the at least two glue-parts are disposed on the at least two cutout portions respectively to adhere the lens barrel to the holder.

6. The lens module as claimed in claim 1, wherein the holder and the main housing of the lens barrel has no gap, wherein the annular internal wall-surface of the holder and the annular external wall-surface of the lens barrel are tightly contacted.

7. A method for assembling a lens module, comprising steps as follows:
providing a holder and a lens barrel; wherein the holder has an annular internal wall-surface formed therein, and a receiving space formed in the annular internal wall-surface; wherein the lens barrel has a main housing, and an annular external wall-surface formed on a periphery of the main housing;
assembling the main housing of the lens barrel in the receiving space of the holder, and tightly fitting the main housing of the lens barrel in the receiving space of the holder, and adjusting a focal distance between the holder and the lens barrel; and
dispensing a glue-part between the holder and the lens barrel for fixedly adhering, after adjusting a focal distance between the holder and the lens barrel.

8. The method for assembling a lens module as claimed in claim 7, wherein the annular internal wall-surface and the annular external wall-surface are conical-shaped, wherein an internal diameter of the annular internal wall-surface is gradually tapered off from one end thereof to the other end thereof, wherein an external diameter of the annular external wall-surface is gradually tapered off from one end thereof to the other end thereof.

9. The method for assembling a lens module as claimed in claim 7, further annularly forming a protruded flange on one end of the main housing, and at least two cutout portions on the protruded flange at intervals; wherein the protruded flange is extended along a radial direction of the main housing and protruded from a periphery of the annular external wall-surface, and the protruded flange is arranged outside of the receiving space of the holder, the protruded flange is adjacent to one end of the holder; and
dispensing the glue-part on the at least two cutout portions respectively to adhere the lens barrel to the holder.

10. The method for assembling a lens module as claimed in claim 7, wherein the holder and the main housing of the lens barrel has no gap, and the annular internal wall-surface of the holder and the annular external wall-surface of the lens barrel are tightly contacted.
